(19) United States
(12) Patent Application Publication
(10) Pub. No.: US 2007/0139344 A1
(43) Pub. Date: Jun. 21, 2007

(54) Active matrix liquid crystal display and driving method and driving circuit thereof

(75) Inventors: Gang-Qiang Zheng, Shenzhen (CN); Jian-Ying Lan, Shenzhen (CN); Hong-Xin Mo, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/642,040

(22) Filed: Dec. 18, 2006

(30) Foreign Application Priority Data
Dec. 16, 2005 (TW) 94144824

(51) Int. Cl. G09G 3/36

(52) U.S. Cl. 345/98

(57) ABSTRACT

An exemplary driving circuit of an active matrix liquid crystal display (LCD) (2) having an LCD panel includes a gate driving circuit (22), a data driving circuit (23), a timing control circuit (21), and a detecting circuit (21). The data driving circuit provides a plurality of gradation voltages to the LCD panel. The detecting circuit (28) is configured for detecting a first voltage difference between a pixel electrode and a common electrode in a first frame, detecting a second voltage difference between the pixel electrode and the common electrode in a second frame, generating an adjusting instruction according to a difference between the first voltage difference and the second voltage difference, and providing the adjusting instruction to the timing control circuit. The timing control circuit controls the data driving circuit to change a gradation voltage according to the adjusting instruction before an inverted gradation voltage is provided to LCD panel.

### FIELD OF THE INVENTION

The present invention relates a driving circuit and an active matrix LCD using the same. The present invention also relates to a driving method of the active matrix LCD.

### GENERAL BACKGROUND

An active matrix LCD device has the advantages of portability, low power consumption, and low radiation, and has been widely used in various portable information products such as notebooks, personal digital assistants (PDAs), video cameras and the like. Furthermore, the active matrix LCD device is considered by many to have the potential to completely replace CRT (cathode ray tube) monitors and televisions.

FIG. 5 is essentially an abbreviated circuit diagram of a typical active matrix LCD. The active matrix LCD 1 includes an LCD panel 17, a data driving circuit 13, a gate driving circuit 12, and a timing control circuit 11. The LCD panel 17 includes a first substrate (not shown), a second substrate (not shown) arranged in a position facing the first substrate, and a liquid crystal layer (not shown) sandwiched between the first substrate and the second substrate. The timing control circuit 11 is used to control the gate driving circuit 12 and the data driving circuit 13.

The first substrate includes a number n (where n is a natural number) of gate lines 101 that are parallel to each other and that each extend along a first direction, and a number m (where m is also a natural number) of data lines 102 that are parallel to each other and that each extend along a second direction orthogonal to the first direction. The first substrate also includes a plurality of thin film transistors (TFTs) 106 that function as switching elements. Each TFT 106 is provided in the vicinity of a respective point of intersection of the gate lines 101 and the data lines 102. The first substrate further includes a plurality of pixel electrodes 103 formed on a surface thereof facing the second substrate.

The second substrate includes a plurality of common electrodes 105 opposite to the pixel electrodes 103. In particular, the common electrodes 105 are formed on a surface of the second substrate facing the first substrate, and are made from a transparent material such as ITO (Indium-Tin Oxide) or the like. A pixel electrode 103, a common electrode 105 facing the pixel electrode 103, and liquid crystal molecules of the liquid crystal layer sandwiched between the two electrodes 103, 105 cooperatively define a single pixel unit.

Each of the TFTs 106 includes a gate electrode “g”, a source electrode “s”, and a drain electrode “d”. The gate electrode “g”, the source electrode “s”, and the drain electrode “d” are connected to a corresponding gate line 101, a corresponding data line 102, and a corresponding pixel electrode 103 respectively. The pixel electrode 103, the corresponding common electrode 105, and the liquid crystal molecules sandwiched between the pixel electrode 103 and the common electrode 105 cooperatively define a liquid crystal capacitor C_{lc}. C_{gd} is a parasitic capacitor formed between the gate electrode “g” and the drain electrode “d” of the TFT 106.

When the active matrix LCD 1 works, the gate driving circuit 12 generates a plurality of scanning signals and sequentially provides the scanning signals to scan the gate lines 101. When a gate line 101 is scanned by the scanning signal, the TFTs 106 connected to the gate line 101 are turned on. At the same time, the data driving circuit 13 generates a plurality of gradation voltages, and provides the gradation voltages to the pixel electrodes 103 via the data lines 102 and the respective activated TFTs 106 in series. The potentials of the common electrodes 105 are set at a uniform potential V_{com}. Thus in each pixel unit, an electric field is generated by the voltage difference between the pixel electrode 103 and the common electrode 105.

The electric field between the pixel electrode 103 and the common electrode 105 is applied to the liquid crystal molecules therebetween. The liquid crystal molecules have anisotropic transmittance. Therefore the amount of light penetrating the substrates at the pixel electrode 103 and the common electrode 105 is adjusted by controlling the strength of the electric field. In this way, a plurality of desired individual pixel light transmissions is obtained, and the combination of these pixel transmissions provides an image viewed on a display screen of the LCD panel 17.

If an electric field between the pixel electrode 103 and the common electrode 105 continues to be applied to the liquid crystal molecules in one direction, the liquid crystal molecules may deteriorate. Therefore in order to avoid this problem, pixel voltages that are provided to the pixel electrode 103 are switched from a positive value to a negative value with respect to a common voltage. This technique is referred to as an inversion drive method.

However, if the positive value of the pixel voltage with respect to the common voltage is larger than the negative value of the pixel voltage with respect to the common voltage, flicker appears on the LCD 1 whenever the pixel voltage is inverted. In order to depress flicker of the LCD 1, the positive value of the pixel voltage and the negative value of the pixel voltage needs to be detected, and appropriate adjustment of one or another of the pixel voltages needs to be performed.

What is needed, therefore, is an active matrix LCD that can reduce or eliminate flicker based on detected pixel voltages thereof. What is also needed is a related driving method for an active matrix LCD.

### SUMMARY

In one preferred embodiment, a driving circuit of an active matrix LCD is provided. The active matrix LCD includes an LCD panel that has a plurality of pixel electrodes and a plurality of common electrodes. The driving circuit includes a gate driving circuit, a data driving circuit, a timing control circuit, and a detecting circuit. The gate driving circuit is configured for scanning the LCD panel. The data driving circuit is configured for providing a plurality of gradation voltages to the LCD panel. The detecting circuit is configured for detecting a first voltage difference between one of the pixel electrodes and a corresponding one of the common electrodes in a first frame, detecting a second voltage difference. between the pixel electrode and the common electrode in a second frame, generating an adjusting instruction according to a difference between the first voltage difference and the second voltage difference, and providing the adjusting instruction to the timing control circuit. The timing control circuit is configured for controlling the data driving circuit to change a gradation voltage according to the adjusting instruction before an inverted gradation voltage is provided to LCD panel driven by an inversion drive method.

Other advantages and novel features will become more apparent from the following detailed description when taken in conjunction with the accompanying drawings.

### BRIEF DESCRIPTION OF THE DRAWINGS

FIG. 1 is essentially an abbreviated circuit diagram of an active matrix LCD according to an exemplary embodiment of the present invention, the active matrix LCD including a subtracter, a comparator, and an adjusting circuit.

FIG. 2 is a circuit diagram of the subtracter of the LCD of FIG. 1.

FIG. 3 is a circuit diagram of the comparator of the LCD of FIG. 1.

FIG. 4 is a circuit diagram of the adjusting circuit of the LCD of FIG. 1.

FIG. 5 is essentially an abbreviated circuit diagram of a conventional active matrix LCD.

### DETAILED DESCRIPTION OF PREFERRED EMBODIMENTS

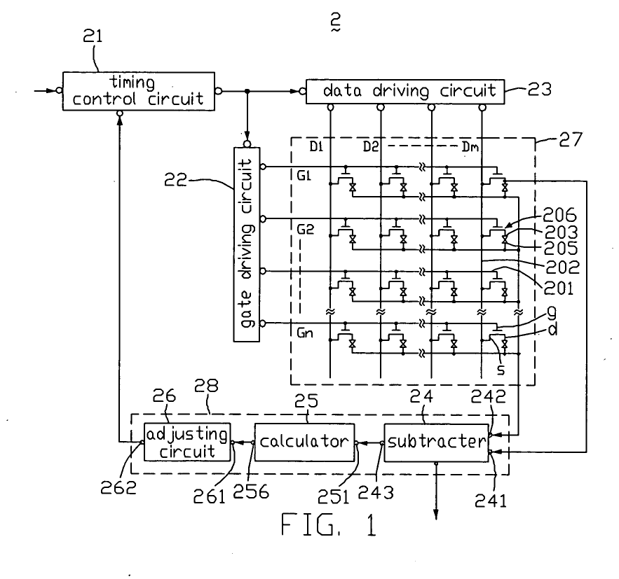

FIG. 1 is essentially an abbreviated circuit diagram of an active matrix LCD according to an exemplary embodiment of the present invention. The active matrix LCD 2 includes an LCD panel 27, a data driving circuit 23, a gate driving circuit 22, a timing control circuit 21, and a detecting circuit 28. The detecting circuit 28 includes a subtracter 24, a calculator 25, and an adjusting circuit 26. The LCD panel 27 is driven by an inversion drive method.

The LCD panel 27 includes a first substrate (not shown), a second substrate (not shown) arranged in a position facing the first substrate, and a liquid crystal layer (not shown) sandwiched between the first substrate and the second substrate.

The first substrate includes a number n (where n is a natural number) of gate lines 201 that are parallel to each other and that each extend along a first direction, and a number m (where m is also a natural number) of data lines 202 that are parallel to each other and that each extend along a second direction orthogonal to the first direction. The first substrate also includes a plurality of TFTs 206 that function as switching elements. Each TFT 206 is provided in the vicinity of a respective point of intersection of the gate lines 201 and the data lines 202. The first substrate further includes a plurality of pixel electrodes 203 formed on a surface thereof facing the second substrate.

The second substrate includes a plurality of common electrodes 205 opposite to the pixel electrodes 203. In particular, the common electrodes 205 are formed on a surface of the second substrate facing the first substrate, and are made from a transparent material such as ITO (Indium-Tin Oxide) or the like. A pixel electrode 203, a common electrode 205 facing the pixel electrode 203, and liquid crystal molecules of the liquid crystal layer sandwiched between the two electrodes 203, 205 cooperatively define a single pixel unit.

Each of the TFTs 206 includes a gate electrode “g”, a source electrode “s”, and a drain electrode “d”. The gate electrode “g”, the source electrode “s”, and the drain electrode “d” are connected to a corresponding gate line 201, a corresponding data line 202, and a corresponding pixel electrode 203 respectively.

The gate driving circuit 22 provides a plurality of scanning signals to the gate lines 201. The data driving circuit 23 provides a plurality of gradation voltages to the data lines 202 when the gate lines 201 are scanned.

Referring also to FIG. 2, the subtracter 24 includes a first input terminal 241 connected to a connecting point (only one shown in FIG. 1) between the drain electrode of each TFT 206 and a corresponding pixel electrode 203, a second input terminal 242 connected to the common electrodes 205, a first output terminal 243, and a second output terminal (not labeled) configured for outputting two voltage differences of two gradation voltages according to the pixel voltage and the common voltage received in two successive frames. The second output terminal outputs these two voltage differences to an external circuit such as a gamma circuit or a crosstalk detecting circuit.

The subtracter 24 further includes a first comparator 2451, a second comparator 2452, a first resistor 2461, a second resistor 2462, a third resistor 2463, a fourth resistor 2464, and a fifth resistor 2465. A resistance of the first resistor 2461 is equal to a resistance of the second resistor 2462. A resistance of the third resistor 2463 is equal to a resistance of the fourth resistor 2464, and is equal to a resistance of the fifth resistor 2465.

The inverting input of the first comparator 2451 is connected to the first input terminal 241 via the first resistor 2461. The noninverting input of the first comparator 2451 is connected to ground. The output of the first comparator 2451 is connected to the inverting input of the second comparator 2452 via the fourth resistor 2464. The noninverting input of the second comparator 2452 is connected to ground. The output of the second comparator 2452 is connected to the output terminal 243. The fifth resistor 2465 is connected between the inverting input and the output of the second comparator 2452. The second resistor 2462 is connected between the inverting input and the output of the first comparator 2451. The inverting input of the second comparator 2452 is also connected to the second input terminal 242 via the third resistor 2463.

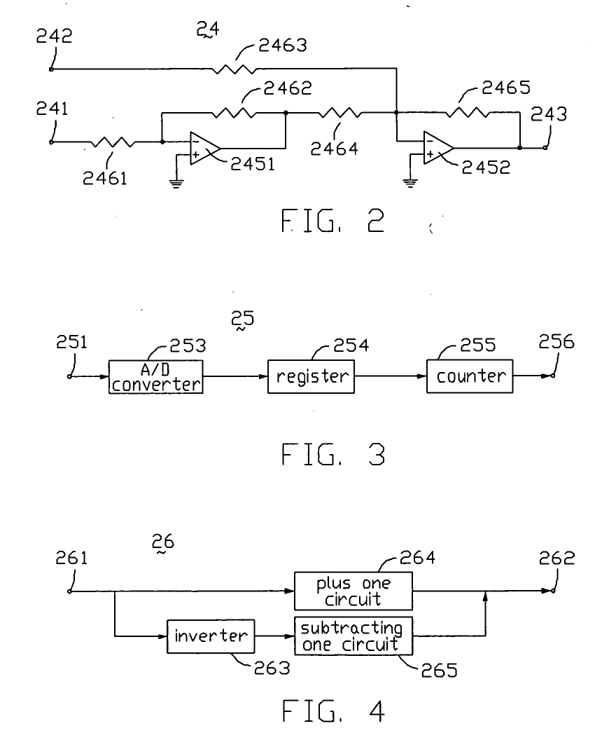

Referring also to FIG. 3, the calculator 25 includes an input terminal 251 connected to the first output terminal 243 of the subtracter 24, an output terminal 256, an analog to digital (A/D) converter 253, a register 254, and a counter 255. The A/D converter 253, the register 254, and the counter 255 are connected in series between the input terminal 251 and the output terminal 256.

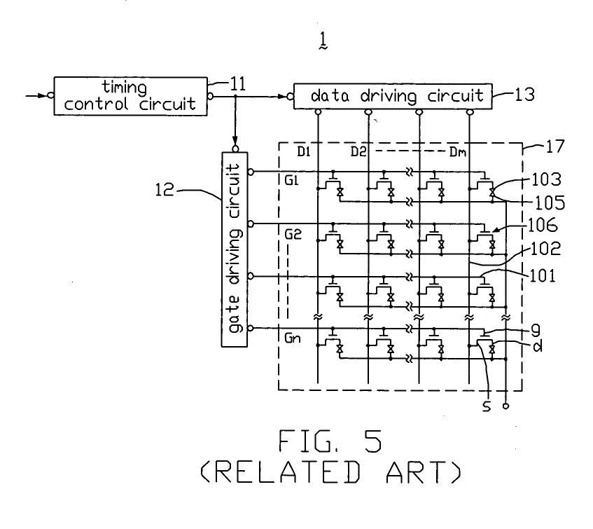

Referring also to FIG. 4, the adjusting circuit 26 includes an input terminal 261 connected to the output terminal 256 of the calculator 25, an output terminal 262 connected to the timing control circuit 21, an inverter 263, a plus one circuit 264, and a subtracting one circuit 265. The inverter 263 and the subtracting one circuit 265 are connected in series between the input terminal 261 and the output terminal 262. The plus one circuit 264 is connected between the input terminal 261 and the output terminal 262.

When the active matrix LCD 2 works, the gate driving circuit 22 generates a plurality of scanning signals and sequentially provides the scanning signals to scan the gate lines 201. When each gate line 201 is scanned by the scanning signal, the TFTs 206 connected to the gate line 201 are turned on. At the same time, the data driving circuit 23 generates a plurality of gradation voltages, and provides the gradation voltages to the pixel electrodes 203 via the data lines 202 and the respective activated TFTs 206 in series. The potentials of the common electrodes 205 are set at a uniform potential V_{com}. Thus in each pixel unit, an electric field is generated by a voltage difference between the pixel electrode 203 and the common electrode 205.

The voltage of the pixel electrode 203 is also provided to the first input terminal 241 of the subtracter 24. The voltage of the common electrode 205 is provided to the second input terminal 242 of the subtracter 24. The subtracter 24 generates two voltage differences of two gradation voltages according to the pixel voltage and the common voltage received in two successive frames, and provides the voltage differences to the calculator 25. The calculator 25 provides a control signal to the adjusting circuit 26 according to the two voltage differences. The adjusting circuit 26 provides an adjusting instruction to the timing control circuit 21 according to the control signal. Thus the timing control circuit 21 controls the data driving circuit 23 to increase or decrease the values of the two corresponding gradation voltages according to the adjusting instruction when the gradation voltages are inverted.

In summary, the active matrix LCD 2 includes the subtracter 24, the calculator 25, and the adjusting circuit 26. The timing control circuit 21 can control the data driving circuit 23 to increase or decrease the gradation voltages according to the adjusting instruction before the inverted gradation voltages are provided to the data lines 202 of the LCD panel 27. Thus any flicker of the active matrix LCD 2 can be depressed or even eliminated.

A driving method of the active matrix LCD 2 according to another exemplary embodiment of the present invention is also provided. The driving method is an inversion drive method, and is described below in relation to one pixel unit. The driving method includes:
step a. A first voltage difference between the pixel electrode 203 and the common electrode 205 in a first frame is detected. In the first frame, the voltage of the pixel electrode 203 is provided to the first input terminal 241 of the subtracter 24. The common voltage of the common electrodes 205 is provided to the second input terminal 242 of the subtracter 24. The subtracter 24 generates a first voltage difference according to the pixel electrode 203 voltage and the common electrode 205 voltage, and provides the first voltage difference to the calculator 25.
step b. A second voltage difference between the pixel electrode 203 and the common electrode 205 in a second frame is detected. The second frame is adjacent to the first frame. In the second frame, the voltage of the pixel electrode 203 is provided to the first input terminal 241 of the subtracter 24. The common voltage of the common electrodes 205 is provided to the second input terminal 242 of the subtracter 24. The subtracter 24 generates a second voltage difference according to the pixel electrode 203 voltage and the common electrode 205 voltage, and provides the second voltage difference to the calculator 25.
step c. A control signal according to a difference between the first voltage difference and the second voltage difference is generated. Detailedly, the A/D converter 253 transforms the first voltage difference and the second voltage difference into a first digital signal and a second digital signal respectively. Then the A/D converter 253 sequentially loads the first and second digital signals to the register 254. The counter 255 accesses the first and second digital signals from the register 254, and generates a control signal according to the first and second digital signals. The control signal can be a positive signal or a negative signal.
step d. An instruction according to the control signal is generated. Detailedly, when the control signal is a positive signal, the plus one circuit 264 receives the control signal. The plus one circuit 264 provides an instruction to add one gradation of the gradation voltage to the timing control circuit 21 according to the control signal. When the control signal is a negative signal, the inverter 263 receives the control signal and provides an inverted control signal to the subtracting one circuit 265. Thus the subtracting one circuit 265 provides an instruction of subtracting one gradation of the gradation voltage to the timing control circuit 21 according to the inverted control signal.
step e. The gradation voltage provided to the pixel electrode 205 according to the instruction is adjusted. Detailedly, the timing control circuit 21 can control the data driving circuit 23 to increase or decrease the gradation voltage according to the adjusting instruction, before the inverted gradation voltage is provided to the data line 202 of the LCD panel 2.

It is to be understood, however, that even though numerous characteristics and advantages of the present embodiments have been set out in the foregoing description, together with details of the structures and functions of the embodiments, the disclosure is illustrative only, and changes may be made in detail, especially in matters of size and arrangement of parts within the principles of the invention to the full extent indicated by the broad general meaning of the terms in which the appended claims are expressed.

What is claimed is:

1. A driving circuit of an active matrix liquid crystal display (LCD), which comprises an LCD panel having a plurality of pixel electrodes and a plurality of common electrodes, the driving circuit comprising:
a gate driving circuit configured for scanning the LCD panel;
a data driving circuit configured for providing a plurality of gradation voltages to the LCD panel;
a timing control circuit configured for controlling the gate driving circuit and the data driving circuit; and
a detecting circuit configured for detecting a first voltage difference between one of the pixel electrodes and a corresponding one of the common electrodes in a first frame, detecting a second voltage difference between the pixel electrode and the common electrode in a second frame, generating an adjusting instruction according to a difference between the first voltage difference and the second voltage difference, and providing the adjusting instruction to the timing control circuit;
wherein the timing control circuit is also configured to control the data driving circuit to change a gradation voltage according to the adjusting instruction before an inverted gradation voltage is provided to the LCD panel driven by an inversion drive method.

2. The driving circuit as claimed in claim 1, wherein the LCD panel comprises a plurality of gate lines that are parallel to each other and that each extend along a first direction, and a plurality of data lines that are parallel to each other and that each extend along a second direction substantially orthogonal to the first direction, a plurality of pixel electrodes, a plurality of common electrodes corresponding to the plurality of pixel electrodes, a plurality of thin film transistors (TFTs) each of which is provided in the vicinity of a respective point of intersection of the gate lines and the data lines, each of the TFTs comprising a gate electrode connected to the corresponding gate line, a source electrode connected to the corresponding data line, a drain electrode connected to a corresponding one of the pixel electrodes.

3. The active matrix LCD as claimed in claim 2, wherein the detecting circuit comprises a subtracter configured for receiving the pixel voltage and the common voltage in the first frame and in the second frame, generating the first and second voltage differences according to the pixel voltage and the common voltage in the first frame and in the second frame, a calculator configured for receiving the first and second voltage differences and generating a control signal accordingly, and an adjusting circuit configured for receiving the control signal and generating the adjusting instruction according to the control signal.

4. The driving circuit as claimed in claim 3, wherein the subtracter comprises an output terminal connected to the calculator, a first input terminal connected to a connecting point between the drain electrode of the corresponding TFT and the pixel electrode, and a second input terminal connected to the common electrodes.

5. The driving circuit as claimed in claim 4, wherein the subtracter further comprises a first comparator, a second comparator, a first resistor, a second resistor, a third resistor, a fourth resistor, and a fifth resistor, the inverting input of the first comparator being connected to the first input terminal via the first resistor, the noninverting input of the first comparator being connected to ground, the output of the first comparator being connected to the inverting input of the second comparator via the fourth resistor, the noninverting circuit of the second comparator being connected to ground, the output of the second comparator being connected to the output terminal, the fifth resistor being connected between the inverting input and the output of the second comparator, the second resistor being connected between the inverting input and the output of the first comparator, the inverting input of the second comparator being connected to the second input terminal via the third resistor.

6. The driving circuit as claimed in claim 5, wherein the a resistance of the first resistor is equal to a resistance of the second resistor, a resistance of the third resistor is equal to a resistance of the fourth resistor and is equal to a resistance of the fifth resistor.

7. The driving circuit as claimed in claim 4, wherein the calculator comprises an input terminal connected to the output terminal of the subtracter and an output terminal connected to the adjusting circuit.

8. The driving circuit as claimed in claim 7, wherein the calculator further comprises an analog to digital (A/D) converter, a register, and a counter, the A/D converter, the register, and the counter being connected in series between the input terminal of the calculator and the output terminal of the calculator.

9. The driving circuit as claimed in claim 7, wherein the adjusting circuit comprises an input terminal connected to the output terminal of the calculator, and an output terminal connected to the timing control circuit.

10. The driving circuit as claimed in claim 9, wherein the adjusting circuit further comprises an inverter, a plus one circuit, and a subtracting one circuit, the inverter and the subtracting one circuit being connected in series between the input terminal of the adjusting circuit and the output terminal of the adjusting circuit, the plus one circuit being connected between the input terminal of the adjusting circuit and the output terminal of the adjusting circuit.

11. An active matrix liquid crystal display (LCD), comprising:
an LCD panel comprising:
a first substrate comprising a plurality of gate lines that are parallel to each other and that each extend along a first direction, a plurality of data lines that are parallel to each other and that each extend along a second direction orthogonal to the first direction, a plurality of pixel electrodes, a plurality of thin film transistors (TFTs) each of which is provided in the vicinity of a respective point of intersection of the gate lines and the data lines, each of the TFTs comprising a gate electrode connected to the corresponding gate line, a source electrode connected to the corresponding data line, a drain electrode connected to a corresponding one of the pixel electrodes;
a second substrate comprising a plurality of common electrodes corresponding to the plurality of pixel electrodes; and
a liquid crystal display sandwiched between the first and second substrates;
a gate driving circuit configured for scanning the LCD panel;
a data driving circuit configured for providing a plurality of gradation voltages to the LCD panel;
a timing control circuit configured for controlling the gate driving circuit and the data driving circuit; and
a detecting circuit configured for detecting a first voltage difference between one of the pixel electrodes and a corresponding one of the common electrodes in a first frame, detecting a second voltage difference between the pixel electrode and the common electrode in a second frame, generating an adjusting instruction according to a difference between the first voltage difference and the second voltage difference, and providing the adjusting instruction to the timing control circuit;
wherein the timing control circuit is also configured to control the data driving circuit to change a gradation voltage according to the adjusting instruction before an inverted gradation voltage is provided to the LCD panel driven by an inversion drive method.

12. The active matrix LCD as claimed in claim 11, wherein the detecting circuit comprises a subtracter configured for receiving the pixel voltage and the common voltage in the first frame and in the second frame, generating the first and second voltage differences according to the pixel voltage and the common voltage in the first frame and in the second frame, a calculator configured for receiving the first and second voltage differences and generating a control signal accordingly, and an adjusting circuit configured for receiving the control signal and generating the adjusting instruction according to the control signal.

13. The active matrix LCD as claimed in claim 12, wherein the subtracter comprises an output terminal connected to the calculator, a first input terminal connected to a connecting point between the drain electrode of the corresponding TFT and the pixel electrode, and a second input terminal connected to the common electrodes.

14. The active matrix LCD as claimed in claim 13, wherein the subtracter further comprises a first comparator, a second comparator, a first resistor, a second resistor, a third resistor, a fourth resistor, and a fifth resistor, the inverting input of the first comparator being connected to the first input terminal via the first resistor, the noninverting input of the first comparator being connected to ground, the output of the first comparator being connected to the inverting input of the second comparator via the fourth resistor, the noninverting circuit of the second comparator being connected to ground, the output of the second comparator being connected to the output terminal, the fifth resistor being connected between the inverting input and the output of the second comparator, the second resistor being connected between the inverting input and the output of the first comparator, the inverting input of the second comparator being connected to the second input terminal via the third resistor.

15. The active matrix LCD as claimed in claim 14, wherein the a resistance of the first resistor is equal to a resistance of the second resistor, a resistance of the third resistor is equal to a resistance of the fourth resistor and is equal to a resistance of the fifth resistor.

16. The active matrix LCD as claimed in claim 13, wherein the calculator comprises an input terminal connected to the output terminal of the subtracter and an output terminal.

17. The active matrix LCD as claimed in claim 16, wherein the calculator further comprises an analog to digital (A/D) converter, a register, and a counter, the A/D converter, the register, and the counter being connected in series between the input terminal of the calculator and the output terminal of the calculator.

18. The active matrix LCD as claimed in claim 16, wherein the adjusting circuit comprises an input terminal connected to the output terminal of the calculator, and an output terminal connected to the timing control circuit.

19. The active matrix LCD as claimed in claim 18, wherein the adjusting circuit further comprises an inverter, a plus one circuit, and a subtracting one circuit, the inverter and the subtracting one circuit being connected in series between the input terminal of the adjusting circuit and the output terminal of the adjusting circuit, the plus one circuit being connected between the input terminal of the adjusting circuit and the output terminal of the adjusting circuit.

20. A driving method of an active matrix liquid crystal display (LCD), comprising:
providing an LCD panel which comprises a plurality of pixel units, each pixel unit comprising a pixel electrode and a common electrode;
detecting a first voltage difference between the pixel electrode and the common electrode in a first frame;
detecting a second voltage difference between the pixel electrode and the common electrode in a second frame;
generating an instruction according to a difference between the first voltage difference and the second voltage difference; and
adjusting the gradation voltage provided to the pixel electrode according to the instruction.
